(19) United States
(12) Patent Application Publication
(10) Pub. No.: US 2024/0213483 A1
(43) Pub. Date: Jun. 27, 2024

(54) FLUOROPOLYMER AND FUNCTIONAL ACRYLIC POLYMER BLEND AS BINDER FOR ELECTROCHEMICAL DEVICES

(71) Applicant: Arkema Inc., King of Prussia, PA (US)

(72) Inventors: Wensheng HE, King of Prussia, PA (US); Jiaxin J. GE, King of Prussia, PA (US)

(21) Appl. No.: 18/285,869

(22) PCT Filed: Apr. 26, 2022
(86) PCT No.: PCT/US2022/026272

§ 371 Date: Oct. 6, 2023

Related U.S. Application Data
(60) Provisional application No. 63/181,438, filed on Apr. 29, 2021.

(51) Int. Cl. H01M 4/62; C09D 5/24; C09D 7/61; C09D 127/16; H01M 10/0525

(52) U.S. Cl. CPC H01M 4/623; C09D 5/24; C09D 7/61; C09D 127/16; H01M 4/625; H01M 10/0525

(57) ABSTRACT

The invention relates to polymer blends comprised of a fluoropolymer and functional acrylic copolymer. The fluoropolymer is majority in the blend, accounting for 80 wt % or higher. The fluoropolymer can be polyvinylidene fluoride (PVDF) and its copolymers. VDF copolymer can contain fluorinated comonomers such as hexafluoropropylene (HFP), tetrafluoroethylene (TFE) etc, or functionalized monomers such as vinyl carboxy lic acid, phosphoric, sulfonic acid and their salts. The functional acrylic copolymers are poly (methyl) methacrylate copolymers with functional containing monomers.

### FIELD OF THE INVENTION

This invention relates to blends of fluoropolymer and acrylic polymers for uses a binders in electrodes or coating in separator in electrochemical devices.

### BACKGROUND OF THE RELATED ART

VDF based Fluoropolymers, PVDF and its copolymers, are used as binder in electrodes or coating in separator in electrochemical devices such as lithium ion batteries. Most common use of PVDF in lithium ion battery are as binder for cathode, and sometimes it is also used as binder for anode. Yet another use of PVDF in lithium ion battery is as coating layer on separators. For binder application, one key property is the adhesion/cohesion of the composite electrode structure. The typical cathode in lithium ion battery is a composite porous structure consisting of active material, conductive carbon additive and binder, coated on to aluminum foil. The adhesion/cohesion of the composite electrode can be characterized by 180° peel test.

Active materials for lithium ion battery cathode can be lithium cobalt oxide, lithium iron phosphate, lithium manganese oxide, lithium nickel-manganese-cobalt oxide, lithium nickel-cobalt-aluminum oxide, etc. Active materials usually accounts for greater than 90% by weight of the cathode composite. Conductive carbon additive can be carbon black, carbon fiber, carbon nanotube, graphite, graphene, etc. its main function is to provide conductive network for electrons, and its proportion in cathode composite is usually 0.5-5 wt %.

In a typical cathode of lithium ion battery, PVDF or its copolymers are the main binder used in industry. The binder composition in cathode is typically in 0.5-5 wt %. One key requirement for the binder is to impart sufficient adhesion/cohesion in the composite electrode structure.

WO 9732347 describes an electrode for a battery comprising an electrode-forming substrate which contains a binder which is used for fixing to the surface of the collector of the battery. This binder contains a PVDF (polyvinylidene fluoride) homopolymer or copolymer grafted with at least one acrylic polymer which comprises acrylic acid and/or methacrylic acid ester groups, the content by weight of this grafted acrylic polymer ranging from 0.1% to 20% of the binder.

WO 9749777 describes a binder which can be used for fixing to a metal which comprises a polyvinylidene fluoride polymer, an acrylic or methacrylic polymer comprising functional groups capable of fixing to a metal and an elastomer of acrylic or methacrylic type. This type of binder cannot be used in a lithium-ion battery electrode as, on contact with the electrolyte, the elastomer will swell and damage the electrode.

US 2013/252077 describes an electrode for a lithium-ion battery which operates with a nonaqueous electrolyte. This electrode comprises an active substance and a binder comprising a vinylidene fluoride polymer and an acrylic polymer. The content by weight of acrylic polymer varies from 40% to 90% and thus causes problems of deterioration of the electrode as a result of the swelling of the abovementioned acrylic polymer, in permanent contact with the electrolyte, in particular when the temperature in the electrode is higher than ambient temperature.

The document EP 2 953 193 describes a binder for a lithium-ion battery comprising a fluoropolymer and an acrylic polymer containing a nitrile group.

The document WO 97/27260 describes an electrode which comprises a collector made of metal coated with a layer comprising an active substance and a binder. This binder comprises at least two of the following three components: a vinylidene fluoride polymer, an acrylic or methacrylic polymer comprising functional groups capable of fixing to the metal and a vinylidene fluoride copolymer. When the binder comprises only the vinylidene fluoride polymer and the acrylic or methacrylic polymer, the latter is in a proportion ranging from 0.5% to 20% by weight of the total weight of the binder. It turns out that, in practice, the weight of binder used has to be sizeable in order to obtain good cohesion of the active layer and good adhesion of the latter to the metal collector. Furthermore, swelling of the cathode in contact with the electrolyte is also observed. The vinylidene fluoride copolymers considered in this document are Kynar® 500 and Kynar® 301 F. These copolymers exhibit a melt flow index (MFR) measured at 1.2 g/10 minutes under 12.5 kg or 4 g/10 minutes under 21.6 kg. A solution of each of these copolymers at a concentration of 5% by weight in N-methyl-2-pyrrolidone exhibits a viscosity of 75 mPa·s at 23° C. It turns out that such viscosity values are not suited to use of such a binder in a lithium-ion battery at a content of less than 5% by weight in the substrate layer covering the metal collector of the battery.

Furthermore, it is known to use, as binder for lithium battery electrodes, a vinylidene fluoride homopolymer of high molecular weight, a 5% solution of which in N-methyl-2-pyrrolidone exhibits a viscosity, measured with a controlled shear rate of 30 revolutions/min, of greater than 100 mPa. This binder has the merit of causing only a limited swelling and of exhibiting only a low content of extractables in the electrolyte, that is to say that, during the use of the electrode, a small amount of products originating from the binder migrates into the electrolyte. It provides good adhesion as a result of the high molecular weight of the abovementioned PVDF homopolymer. On the other hand, as this same polymer has a high molecular weight, it is thus very viscous and it is consequently difficult to spread, over the metal collector, the paste formed by the mixture of this binder with the active substance of the electrode.

One example is to use functionalized acrylic additive, as disclosed in US patent application US 2018/0355206. US 2018/0355206 teaches that the acrylic copolymer has 10 mol % acid bearing monomer, i.e. methacrylic acid to obtain better peel.

The standard acrylic copolymers do not have the stability needed for application in battery.

There is continuous need to improve binder's adhesion/cohesion property in battery industry in order to reduce binder loading and increase overall energy density of battery.

Surprisingly, the present invention demonstrates that acrylic copolymer with less than 10 mol % functionality can significantly boost adhesion/cohesion of PVDF binder. This invention also discloses that comonomer other than MAA can have similar effect in boosting adhesion/cohesion. The invention provides for blend of acrylics that have high Tg with PVDF that provide a binder with excellent bonding adhesion for use in batteries.

### SUMMARY OF THE INVENTION

The invention relates to polymer blends comprised of a fluoropolymer and at least one functional acrylic copolymer. The fluoropolymer is the majority in the blend, accounting for 80 wt % or higher, preferably 90 or greater % by weight.

The fluoropolymer is preferably a polyvinylidene fluoride (PVDF) homopolymer or copolymer.

The functional acrylic copolymers are poly(methyl methacrylate) copolymers comprising greater than 0.5 mol. % and less than 10 mol % functional acrylic monomer units, preferably from 0.5 to 8 mol. % functional monomer units and more preferably from 1 to 8 mol % functional monomer units and optionally containing hydrophobic monomer.

The functional acrylic polymer accounts for equal to or greater than 1 wt % in the polymer blend. Aspects of the invention

Aspect 1: A binder for a lithium-ion battery comprising at least one vinylidene fluoride polymer and at least one acrylic copolymer, said acrylic copolymer comprising monomers comprising functional groups exhibiting an affinity for metals or which are capable of becoming fixed to metals, wherein said acrylic copolymer has a Tg of greater than 110 C and comprises functional monomers comprising at least one type of functional group chosen from among the following groups: carboxyl, hydroxyl, carboxylic acid anhydride and epoxy, and wherein a 5% by weight solution of said vinylidene fluoride polymer in N-methyl-2-pyrrolidone exhibits a viscosity, measured at 23° C. with a controlled shear rate of 30 revolutions/min, equal to or greater than 125 millipascal-seconds, and less than 2000 millipascal-seconds, wherein the acrylic copolymer comprise less than 10 mol percent functional monomers, preferably 8 mol percent or less and most preferably 7 mole percent or less, and wherein the fluoropolymer comprises greater than 80 wt % of the total weight of polymers in the polymer blend.

Aspect 2: The binder of aspect 1, wherein said binder contains, by weight, a content of acrylic copolymer equal to or greater than 2% and equal to or less than 15% by weight of the total weight of polymers in the polymer blend.

Aspect 3: The binder of aspect 2, wherein said binder contains, by weight, a content of acrylic copolymer equal to or less than 10%.

Aspect 4: The binder of any of aspects 1 to 3, wherein the viscosity of said solution of 5% by weight PVDF is equal to or greater than 300 millipascal-seconds, and less than 1500 millipascal-seconds.

Aspect 5: The binder of any of aspects 1 to 4 wherein the vinylidene fluoride polymer is a copolymer comprising at least one monomer selected from the group consisting of hexafluoropropylene (HFP), tetrafluoroethylene (TFE), functionalized monomers such as vinyl carboxylic acid, phosphoric, sulfonic acid and salts.

Aspect 6: The binder of any of aspects 1 to 5, wherein said acrylic copolymer has a molecular weight of greater than 80,000 g/mol, preferably greater than 100,000 g/mol.

Aspect 7: The binder of any of aspects 1 to 6, wherein said acrylic copolymers have high heat resistance as measure by having a Tg of greater 110° C., preferably higher than 115° C., more preferably higher than 120° C.

Aspect 8: The binder of any of aspects 1 to 7, wherein said acrylic copolymer comprises functional monomers comprising at least one type of functional group chosen from the following groups: carboxyl and hydroxyl.

Aspect 9: The binder of any of aspects 1 to 7, wherein said acrylic copolymer comprises a poly(methyl methacrylate) copolymer comprising a functional monomer having a carboxyl functional group.

Aspect 10: The binder of any of aspects 1 to 7, wherein said acrylic copolymer comprises methyl methacrylate units and methacrylic acid units.

Aspect 11: The binder of any of aspects 1 to 7, wherein said acrylic copolymer comprises methyl methacrylate units and carboxylalkyl acrylate units or carboxylalkyl methacrylate units.

Aspect 12: The binder of any of aspects 1 to 11, wherein said acrylic copolymer further comprises a hydrophobic monomer.

Aspect 13: The binder of aspect 12, wherein said hydrophobic monomer is an acrylic monomer having a substituted cycloalkane group.

Aspect 14: The binder of aspect 12, wherein said hydrophobic monomer is selected from the group consisting of carboxylalkylacrylate monomer or oligomer, as for example, tert-butyl cyclohexyl (meth)acrylate, 3,3,5-trimethylcyclohexyl(meth)acrylate, isobornyl methyl acrylate (IBOMA) and isobornyl acrylate (IBOA).

Aspect 15: The binder of any of aspects 1 to 14, wherein the mol % of the hydrophobic monomer units is for 0 to 15 mol %, preferably from 0.5 to 10 mol %.

Aspect 16: An electrode for a lithium-ion battery of the type comprising a metal collector, at least one face of which is covered with a layer of substrate containing an active substance and the of any of aspects 1 to 15.

Aspect 17: The electrode of aspect 16, wherein said substrate contains, by weight, a content of said binder of equal to or greater than 0.5% and of equal to or less than 5%.

Aspect 18: The electrode of aspect 16, wherein said substrate contains, by weight, a content of said binder equal to or greater than 1% and of equal to or less than 3%.

Aspect 19: The electrode of any of aspects 16 to 18, wherein said active substance comprises a lithium metal oxide and optionally carbon black.

Aspect 20: The electrode of any of aspects 16 to 18, wherein said active substance comprises at least one ingredient chosen from coke, carbon black, graphite, activated carbon and carbon fibers.

Aspect 21: The electrode of any of aspects 16 to 20, wherein the viscosity of said solution of 5% by weight PVDF is equal to or greater than 300 millipascal-seconds, and less than 1200 millipascal-seconds.

### DETAILED DESCRIPTION OF THE INVENTION

The references cited in this application are incorporated herein by reference.

Percentages, as used herein are weight percentages (wt. %), unless noted otherwise, and molecular weights are weight average molecular weights (Mw), unless otherwise stated. Molecular weight is measured by gel permeation chromatography (GPC) using PMMA (Polymethylmethacrylate) standards. Melt viscosity (MV) is measured at 230° C. at 100 sec-1. Glass transition temperature was measured using differential scanning calorimetry (DSC) under ASTM 3418: The glass transition temperatures of acrylic polymers was measured at a heating rate of 10° C./minutes in N₂, during the second heating. The first heating was used to heat the sample to 170° C. at a heating rate of 10° C./minute, then, the sample was cooled down to 0° C. at a cooling rate of 10° C./minute. Melt viscosity are according to ASTM D3835 by a capillary rheometry at 230° C. and 100 sec-1.

“Copolymer” is used to mean a polymer having two or more different monomer units, including terpolymers and higher degree polymers. “Polymer” is used to mean both homopolymer and copolymers. For example, as used herein, “PVDF” and “polyvinylidene fluoride” are used to connote both the homopolymer and copolymers, unless specifically noted otherwise. The polymers may be homogeneous, heterogeneous, or random, and may have a gradient distribution of co-monomer units.

By “(meth)acrylic” or “(meth)acrylate” as used herein denotes both the acrylate and the methacrylate. (Meth)acrylate is used to connote both acrylates and methacrylates, as well as mixtures of these. Polymers may be straight chain, branched, star, comb, block, or any other structure.

“Amphiphilic polymers” are long chain molecules that simultaneously contain hydrophobic and hydrophilic components.

The present invention relates to a binder comprising a functional acrylic polymer and PVDF which can be used for a lithium-ion battery, and also to the associated electrode. The functional acrylic preferably contains less than 10 wt % functional monomer units, more preferably 8 mol % or less functional monomer units in the functional acrylic polymer.

The present invention relates to a binder which can be used in a lithium-ion battery and which comprises at least one vinylidene fluoride polymer and at least one acrylic copolymer comprising monomers bearing functional groups exhibiting an affinity for metals or which are capable of becoming fixed to metals. The acrylic copolymer is a copolymer of methyl methacrylate and functional acrylic monomer.

An aim of the present invention is to provide a binder as mentioned above which confers good adhesion between the metal and the layer of PVDF-containing material.

Another aim of the present invention is to provide a binder which makes it possible to easily spread the active substance over the metal collector and thus facilitates the manufacture of an electrode for a lithium-ion battery.

Another aim of the invention is to provide a binder which reduces organic solvent usage during electrode processing step

Another aim of the present invention is to provide an electrode for a lithium-ion battery.

Another aim of the present invention is to provide an electrode which comprises a relatively low content by weight of binder in order to make it possible to increase the content of active filler in the cathode in order to maximize the capacity of the batteries.

### Binder

The invention relates to polymer blends comprised of a fluoropolymer and at least one functional acrylic copolymer for use as a binder in batteries. The fluoropolymer is the majority in the polymer blend, accounting for 80 wt % or higher, preferably 80 to 98% by weight, more preferably 90 to 98% by weight. Preferably, the binder contains, by weight, a content of acrylic copolymer of equal to or greater than 2 wt % and of equal to and less than 20 wt %, in particular of less than or equal to 15 wt % or less than or equal to 10 wt % based on total polymer in the binder.

Blending functional acrylic polymer with fluoropolymer provides for improved mechanical performance, such as increased adhesion, through dipole-dipole interactions between PVDF and acrylic copolymer. The fluoropolymer/acrylic blends of this invention are suitable for electrode binder or separator coating application in lithium ion batteries, where improved adhesion/cohesion or bonding strength are desired. The functional acrylic copolymer is comprised of less than 10 mol %, preferable less than 8 mol % of monomer units bearing functional groups in the acrylic copolymer. The mol % of functional monomer in the acrylic polymer is from 0.5 to less than 10 mol %, preferably 1 to 8 mol %. Preferably the functional group is a carboxylic acid functional group.

It is believed that the presence of the acrylic copolymer facilities the application of the active substance during the manufacture of the electrode, as a result of the decrease in the viscosity of the binder/active substance mixture. Furthermore, as a result of the decrease in the viscosity of the binder and thus of the binder/active substance mixture, the amount of organic solvent which has to be used in the manufacture of an electrode is reduced; the use of the binder according to the invention is thus more ecological.

The binder of the invention does not contain elastomeric polymer or elastomerie copolymer, in particular elastomeric (co)polymer of acrylic type, and the polymer of acrylic type is not an elastomer.

The fluoropolymer/acrylic blend of the invention is not an acrylic modified fluoropolymer such as described in U.S. Pat. Nos. 6,680,357 or 6,635,714. In the present invention the polymers polymerized in separate polymerization processes and then are admixed or blended together through physical means.

### Fluoropolymer

The PVDF of the invention is a vinylidene fluoride homopolymer or copolymer having greater than 50 weight percent of vinylidene fluoride monomer units by weight, preferably more than 65 weight percent, more preferably greater than 75 weight percent and most preferably greater than 90 weight percent of vinylidene fluoride monomers.

Vinylidene fluoride polymers copolymers include those containing at least 50 weight %, preferably at least 75 weight %, more preferably at least 80 weight %, and even more preferably at least 90 weight % of vinylidene fluoride copolymerized with one or more comonomers. Example comonomers may be selected from the group consisting of tetrafluoroethylene (TFE), trifluoroethylene (TrFE), chlorotrifluoroethylene (CTFE), 1,2-difluoroethylene, perfluorobutylethylene (PFBE), hexafluoropropene (HFP), vinyl fluoride (VF), pentafluoropropene, tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, and any other monomer that would readily copolymerize with vinylidene fluoride, one or more of partly or fully fluorinated alpha-olefins such as 3,3,3-trifluoro-1-propene, 2-trifluoromethyl-3,3,3-trifluoropropene, 1,2,3,3,3-pentafluoropropene, 3,3,3,4,4-pentafluoro-1-butene, hexafluoroisobutylene (HFIB), fluorinated dioxoles, such as perfluoro(1,3-dioxole) and perfluoro(2,2-dimethyl-1,3-dioxole) (PDD), partially- or per-fluorinated alpha olefins of C4 and higher, partially- or per-fluorinated cyclic alkenes of C3 and higher, allylic, partly fluorinated allylic, or fluorinated allylic monomers, such as 2-hydroxyethyl allyl ether or 3-allyloxpropanediol, and ethene or propene and combinations thereof. Other monomers units in these polymers may include any monomer that contains a polymerizable C═C double bond. Additional monomers could be 2-hydroxyethyl allyl ether, 3-allyloxypropanediol, allylic monomers, ethene or propene, acrylic acid, methacrylic acid.

In one preferred embodiment the fluoropolymer is an acid functionalized fluoropolymer preferably acid functionalized PVDF.

Methods of producing acid functionalized fluoropolymers are known in the art. WO2019/199753, WO2016149238 and U.S. Pat. No. 8,337,725 the content of each are herein incorporated by reference, provide some known methods of producing acid functionalized fluoropolymers.

In one embodiment, up to 30%, preferably up to 25%, and more preferably up to 15% by weight of hexafluoropropene (HFP) units and 70% or greater, preferably 75% or greater, more preferably 85% or greater by weight or more of VDF units are present in the vinylidene fluoride polymer.

Preferably, the vinylidene fluoride polymer is such that the viscosity of a solution of N-methyl-2-pyrrolidone containing 5% by weight of said vinylidene fluoride polymer, measured at 23° C. with a controlled shear rate of 30 revolutions/min, is equal to or greater than 125 mPa·s and preferably equal to or greater than 300 mPa·s and preferably equal to or greater than 300 mPa·s and less than 2000 mPa·s, less than 1500 mPa·s and preferably less than 1200 mPa·s.

The type of vinylidene fluoride polymer mentioned above exhibits a molar weight of the order of a million grams and is already used as binder for lithium-ion batteries. Its mixture with an acrylic copolymer makes it possible to reduce the viscosity of the binder and thus that of the paste which is used to manufacture a lithium-ion battery electrode; it is thus easier to manufacture the electrode. Nevertheless, it was not obvious that the addition of the functionalized acrylic polymer in an amount of less than 10 weight percent preferably less than 8 weight percent, with a molar mass far lower than that of PVDF, would very significantly increase the adhesion. This is because it is known to a person skilled in the art that the higher the molar mass of the binder, the more satisfactory the adhesion of the binder to the metal plate, which also improves the cohesion of the electrode comprising this binder.

It is possible to manufacture electrodes for lithium-ion batteries which contain a reduced amount of binder, which makes it possible to increase the content of active filler in the cathode and to thus increase the charge capacity of the latter.

### Acrylic Polymers

The acrylic polymer of the invention comprises a majority of polymethylacrylate monomer units (greater than 50%, preferably greater than 80 mol %) the acrylic polymer comprises less than 10 mol % preferably 8 mol % or less, or 7% or less of acrylic monomer units having functional groups (“functional monomer”). The functional groups capable of becoming fixed to metals or exhibiting an affinity for the latter are well known to a person skilled in the art. They can contain, for example, at least one type of group chosen from the following groups: carboxylic acid, hydroxyl, carboxylic anhydride and epoxy. Preferably, the acrylic copolymer comprises monomers comprising carboxylic acid functional groups or carboxyl functional groups, most preferably carboxylic acid functional groups.

In some embodiments, the acrylic copolymer comprises carboxylalkylacrylate or carboxylalkylmethacrylate units.

Non limiting examples of monomers having functional groups include (meth) acrylic acids such as 2-carboxyethyl acrylate (CEA), acrylic acid and meth acrylic acid.

In some embodiments, the acrylic copolymer comprises a hydrophobic monomer units in addition to the monomer containing the functional group, resulting in an amphiphilic acrylic copolymer. The mol % of the hydrophobic monomer units is for 0 to 15 mol %, or from 0.5 to 10 mol % or from 0.5 to 8 mol %. One example of a hydrophobic monomer is an acrylic monomer bearing a substituted cycloalkane group.

In some embodiments, the hydrophobic acrylic copolymer comprises carboxylalkylacrylate monomer units or oligomers, as for examples tert-butyl cyclohexyl (meth)acrylate, 3,3,5-trimethylcyclohexyl(meth)acrylate, isobornyl methyl acrylate (IBOMA) and isobornyl acrylate (IBOA).

The acrylic copolymer may optionally contains additional acrylate and methacrylate monomers or other ethylenically unsaturated monomers, included but not limited to, styrene, alpha methyl styrene, acrylonitrile. Suitable acrylate and methacrylate comonomers include, but are not limited to, methyl acrylate, ethyl acrylate and ethyl methacrylate, butyl acrylate and butyl methacrylate, iso-octyl methacrylate and iso-octyl acrylate, lauryl acrylate and lauryl methacrylate, stearyl acrylate and stearyl methacrylate, isobornyl acrylate and isobornyl methacrylate, methoxy ethyl acrylate and methoxy methacrylate, 2-ethoxy ethyl acrylate and 2-ethoxy ethyl methacrylate, and dimethylamino ethyl acrylate and dimethylamino ethyl methacrylate monomers.

In some embodiments the acrylic polymer is a PMMA/hydrophilic 2-carboxyethyl acrylate (CEA) polymer with a Tg of greater than 100 C and MW above 100,000 g/mol. In some embodiments the acrylic polymer is a PMMA/hydrophilic 2-carboxyethyl acrylate (CEA) polymer further comprising hydrophobic monomer units selected from the group tert-butyl cyclohexyl methacrylate, 3,3,5-trimethylcyclohexyl(meth)acrylate, isobornyl methyl acrylate (IBOMA), and isobornyl acrylate (IBOA), with a Tg of greater than 100 C and MW above 100,000 g/mol. High heat acrylic copolymers containing functional CEA maintain high Tg and improved bonding adhesion.

The acrylic copolymers possess high heat resistance as measure by having a Tg of greater 110° C., preferably higher than 115° C., more preferably higher than 120° C., general the Tg is in the range of from 110 C to 140 C.

The weight average molecular weight of the acrylic copolymers is higher than 65,000 g/mole, preferably higher than 80,000 g/mole, more preferably higher than 100,000 g/mole.

The acrylic copolymer or the mixture of acrylic (co)polymers is not an elastomer, that is to say that it does not exhibit a glass transition temperature of less than 20° C.

Advantageously, the acrylic copolymer contains less than 10 mol % of monomers bearing functional group, preferably 8 mol % or less of groups exhibiting an affinity for metals or capable of becoming fixed to metals, preferably acid functional groups and optionally contains hydrophobic monomers. The Applicant Company has demonstrated that such a copolymer would confer good adhesion on the material containing it and deposited on a metal sheet.

### Electrode

The present invention also relates to an electrode for a lithium-ion battery of the type comprising a metal collector, at least one face of which is covered with a layer of substrate containing an active substance and a binder which characteristically comprises the binder according to the invention or consists of the binder according to the invention.

The active substance which can be used for the formation of the anode or of the cathode is well known to a person skilled in the art.

The electrode can be a cathode and, in this case, the substrate can contain, as active substance, a lithium metal oxide and optionally carbon black.

The electrode can also be an anode and, in this case, said substrate can contain, as active substance, at least one ingredient chosen from coke, carbon black, graphite, activated carbon and carbon fibers.

The solution viscosity is measured using a Brookfield rotary viscometer comprising a spindle of SC4-34 type.

The present invention, its characteristics and the various advantages which it provides will become more clearly apparent on reading the examples which follow and which are provided as explanatory and nonlimiting examples.

### EXAMPLES

PVDF1 is a VDF homopolymer with a melt viscosity of between 4450 Pa·s and 5450 Pa·s according to ASTM D3835 at 230 C and 100s-1.

Acrylic PMMA-MAA with 10% or less MAA, with <0.1-10wt % addition to PVDF base binder. Example of base PVDF was PVDF1, for cathode binder application. Functionalized PMMA copolymers used in the examples and their key properties are list in Table 1.

TABLE 1
Acrylic polymer additives

| | | | | | | Weight |
|---|---|---|---|---|---|---|
| | | | | | | average |
| | | | | | | molecular |
| | Grade | | Wt. % of co- | | Tg | weight (Mw, |
| | name | Co-monomer(s) | monomer(s) | Mol % | (° C.) | g/mole) |
| Example 1 | PMMA1 | MAA | 4.5 wt. % | 5.2 | 122 | 85,000 |
| Example 2 | PMMA2 | MAA | 6.0 wt. % | 6.9 | 126 | 115,000 |
| Example 3 | PMMA3 | MAA + BCHMA | 4.0% + 1.5% | 4.7 + 0.7 | 121 | 105,000 |
| Example 4 | PMMA4 | CEA | 5.2 | 3.7 | 123 | 130,000 |
| Comparative 2 | PMMA5 | EA | 0.6% | 0.6 | 114 | 109,000 |

### Preparation of Polymer Blend Binder Solution

8.0 wt. % PVDF solution is made by adding 92 g of N-Methyl-2-Pyrrolidone (NMP, Biograde from Alfa Aesar) to 8.0 g of PVDF 1 and mixed on a heated roll mixer at ˜60° C. overnight. 8.0 wt. % acrylic solution was prepared by dissolving 1.0 g of acrylic copolymer in 11.5 g of NMP and mixed in the same fashion.

One way to make uniform polymer blend is by solution blending. Appropriate amount of PVDF solution and Acrylic solution are added to a vail, and then roll mixed overnight. For example, to make a 95:5 PVDF/Acrylic blend solution, 19 g of 8 wt. % PVDF solution and 1 g of wt. 8% Acrylic solution are mixed together. In all the cases, the total binder (PVDF+Acrylic) concentration is 8.0 wt %.

### Cathode Formulation and Fabrication

Two exemplary cathode slurry preparation procedures for laboratory scale are described here. Process #1 mix carbon black with binder solution first then mixed with active material. Process #2 mix carbon black and active material as dry powders, then mixed with binder solution. Both processes are used in lithium ion battery industry. The following procedures are for laboratory scale with targeted formulation of NMC622/SuperP/Binder=97/1.5/1.5 on dry basis.

### Slurry Process #1

0.36 g conductive carbon additive, SuperP-Li from Timcal, is added to 4.5 g of the 8.0% binder solution, and mixed using a centrifugal planetary mixer, Thinky AR-310, for 3 repeats of 120 s at 2000 rpm with 1 min air cooling in between. Once the conductive carbon is dispersed in the binder solution, 23.28 g of active material, Celcore® NMC622 (Umicore), and small amount of NMP (0.5 g) are added to the mixture, and mixed to form a thick and uniform paste, typically 60 s at 2000 rpm. Then small amount of NMP (0.5 g) is added to the paste and mixed at 60 s/2000 rpm to gradually reduce the slurry solids and viscosity. This dilution step is repeated multiple time until the slurry viscosity reaches proper level for coating, typically 3,000-15,000 cP @1/s shear rate. Typically the final solids level for NMC622/SuperP/Binder=97/1.5/1.5 formulation is around 80wt. %.

### Electrode Casting and Drying

The cathode slurry is then cast onto aluminum foil (current collector, 15 microns thick) using adjustable doctor blade on an automatic film applicator (Elcometer 4340) at 0.3 m/min coating speed. The gap of doctor blade is empirically adjusted to give a dry thickness of about 80 micron, or mass loading of around 200 g/m². The wet casting is then transferred to a convection oven, and dried at 120° C. for 30 min. After drying, the electrode is calendared using a roll mill (HSTK-1515H by Hohsen), the final density of a NMC622 based electrode is usually around 3.4 g/cm³.

### Peel Test

For Peel test, the samples are cut into 1″ wide stripes of 5-8″ long. Samples are dried in a vacuum oven at ˜85° C. overnight, then stored in dry room. Peel strengths for cathodes were obtained via a 180° peel test using ASTM D903 with several modifications. The first modification was that the extension rate used was 50 mm/minute (peel rate of 25 mm/minute). The second modification was that test samples dried (as describe above) prior to peel test, and the peel test was conducted inside dry room, because variation in exposure to ambient moisture can have significant impact on the peel results. The 1″ wide test stripe is bonded to the alignment plate via 3M's 410M double sided paper tape with the flexible aluminum foil current collector peeled by the testing machine's grips. The mechanical tester is an Instron 3343 model with a 10N load cell. Peel results are reported in N/m.

### Example 1

Cathodes were prepared using slurry process 1 with solution blended PVDF1/PMMA1 of various ratio or additive level from 2-6 wt % on total binder basis (PVDF1+Acrylic). The active materials used was Celcore® NMC622, carbon additive was Super-P, and the cathode composition was NMC622/SuperP/Binder=97/1.5/1.5 on dry basis. The mass load of the cathodes examples was around 205 g/m², and final compressed density was around 3.4 g/cm³.

There are multiple factors can affect the absolute value of the peel rest results. For example, ambient condition (humidity and temperature) during the slurry preparation, slurry mixing protocols, and peel sample conditioning protocols all can have significant impact on the absolute value. It is more meaningful if we compare the relative valve against a control, in this case we choose the neat PVDF PVDF1 sample as a control. The ambient condition for examples are 26-29° C., RH ˜12%.

### Comparative 1

Same process is followed as example 1, except the binder was neat battery grade PVDF1, without any additive.

TABLE 2
Examples 1 MMA

| | | Blend | Slurry | Peel, | Relative to |
|---|---|---|---|---|---|
| Examples | Binder | method | process | N/m | PVDF1 |
| Compara- | PVDF1 | N/A | 1 | 77 | 100% |
| tive 1 | | | | | |
| Example 1.1 | PVDF1/PMMA1 = | Solution | 1 | 77 | 100% |
| | 98/2 | | | | |
| Example 1.2 | PVDF1/PMMA1 = | Solution | 1 | 120 | 156% |
| | 96/4 | | | | |
| Example 1.3 | PVDF1/PMMA1 = | Solution | 1 | 107 | 139% |
| | 95/5 | | | | |
| Example 1.4 | PVDF1/PMMA1 = | Solution | 1 | 108 | 140% |
| | 94/6 | | | | |

The level of addition has significant impact on the final peel strength of the cathode composite. The minimal addition level is greater than 2 wt % in this case. Adding small amount (4-6 wt. %) of PMMA1 to PVDF1, boosted the peel strength of 39-56% over the PVDF1control. PMMA1 containing 4.5 wt. % MAA co-monomer possessed the Tg of 122° C. measured in DSC. The weight average molecular weight Mw of the resin was measured as being 85,000 g/mole using GPC along with a Mw/Mn (polydispersity) value of 1.9.

For comparative purposes, the following examples all use the 5 wt. % (PVDF1/additive=95/5) level.

### Example 2

The binder used are PVDF1/PMMA2 at 95/5 blend ratio via solution blending. PMMA2, which is PMMA-MAA with higher molecular weight than PMMA1. The cathode was prepared using slurry procedure #1, and has a nominal composition NMC622/SuperP/Binder=97/1.5/1.5 on dry basis. The mass load of the cathodes examples was around 205 g/m², and final compressed density was around 3.4 g/cm³.

PMMA2 copolymer containing 6 wt. % MAA was made from mass polymerization at 160° C. when the conversion was >50%. The glass transition temperature of the resin was measured to be 126° C. in N₂ using DSC at the heating rate of 10° C./minute. The weight average molecular weight Mw of the resin was measured as being 115,000 g/mole using GPC along with a Mw/Mn (polydispersity) value of 1.9.

### Comparative 2

The same process was followed as example 2, except the additive was PMMA5, which is a PMMA5 (ethyl acrylate) copolymer. PMMA5 containing 0.6 wt. % EA possessed the Tg of 114° C. measured in DSC. The weight average molecular weight Mw of the resin was measured as being 109,000 g/mole using GPC along with a Mw/Mn (polydispersity) value of 1.9.

### Example 3

The same process was followed as example 2, except the additive was PMMA3, which is amphiphilic, has higher molecular weight and third monomer to fine-tune the dipole-dipole interaction with PVDF.

PMMA3 copolymer containing 4 wt. % MAA and 1.5 wt. % tert-butyl cyclohexyl methacrylate (BCHMA, from Sartomer) was made from mass polymerization at 160° C. when the conversion was >50%. The glass transition temperature of the resin was measured to be 121° C. in N₂ using DSC at the heating rate of 10° C./minute. The weight average molecular weight Mw of the resin was measured as being 105,000 g/mole using GPC along with a Mw/Mn (polydispersity) value of 1.9.

### Example 4

The same process was followed as example 2, except the additive was PMMA4, acrylic copolymer with 2-carboxyethyl acrylate instead of MAA

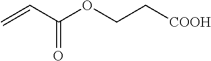

PMMA4 copolymer made from solution polymerization in toluene at 70° C.: This example demonstrates the preparation of a high molecular weight copolymer of methyl methacrylate and 2-carboxyethyl acrylate. 94.80 parts of methyl methacrylate and 5.20 parts of 2-carboxyethyl acrylate (2-CEA from Aldrich) were charged into a reaction vessel containing 300 parts of toluene near 23° C. with a mechanical stirring speed of 380rpm. AIBN (from Aldrich) was used as an initiator at a level of 0.241_parts. The polymerization reaction occurred at 65-68° C. for 6 hours. When the conversion reached >50%, the residual monomers were removed through a precipitation in methanol (MeOH,×20 times). Then, the solid polymer powder was dissolved in acetone at the solid content of 25 wt. % and the polymer solution was precipitated in sufficient MeOH again. The re-precipitated white powder samples were dried at 180° C. in a vacuum oven over 16 hours.

PMMA4 The glass transition temperature of the resin was measured to be 123° C. in N₂ using DSC at the heating rate of 10° C./minute. The weight average molecular weight Mw of the resin was measured as being 130,000 g/mole using GPC along with a Mw/Mn (polydispersity) value of 1.8.

Environmental ambient conditions can affect the absolute value of peal. The relative value is not affected. Examples 2-4 and Comparative example were run under the same ambient environmental conditions.

TABLE 3
Examples 2-4

| | | function- | Blend | Slurry | Peel, | Relative |
|---|---|---|---|---|---|---|
| Examples | Additive | ality | method | process | N/m | to PVDF1 |
| Compara- | None | None | N/A | 1 | 77 | 100% |
| tive 1 | | | | | | |
| Compara- | PMMA5 | EA | Solution | 1 | 87 | 112% |
| tive 2 | | | | | | |
| Example 2 | PMMA2 | MAA, | Solution | 1 | 111 | 145% |
| | | higher | | | | |
| | | Mw | | | | |
| Example 3 | PMMA3 | MAA + | Solution | 1 | 142 | 184% |
| | | BCHMA | | | | |
| Example 4 | PMMA4 | CEA | Solution | 1 | 107 | 139% |

The blending of The small amount (5 wt. %) of different acid functional acrylic copolymers into PVDF1 base resin dramatically boosted the peel mechanical strength of 39-84% over that in the PVDF1 control.

Comparative example 2 is PVDF1 blended with PMMA5 which has no acid functionality, as can be seen, its effectiveness in boosting peel strength is limited to a certain degree as compared to other acrylic copolymers with acid functional monomers in Examples 2, 3 and 4. Example 2 has higher molecular weight, which turned out to improve peel strength. Example 3 with PMMA3 has higher Mw, and a third monomer to adjust dipole-dipole interactions with PVDF, which has showed significant improvement in peel strength. Example 4 has demonstrated 2-carboxyethyl acrylate (CEA) that can deliver similar improvement as MAA commoner.

The peal test for Examples 5 to 7 and under similar ambient environmental conditions to each other to be able to compare the results.

### Example 5 (Functional pMMA Copolymer Containing 2-CEA Blended with PVDF 1)

The blended dry coating of 95 wt % PVDF1 and 5 wt. % of pMMA/2-carboxyethyl acrylate (97.8/2.2 weight/weight) Tg=123 C, MW=130,000 copolymer exhibited 180 N/m of peel bonding adhesion over the Al foil in battery cathode binders using 180 degree peel adhesion tests against 105 N/m from PVDF1 control.

### Example 6 (Functional pMMA Copolymer Containing 2-CEA+MAA Blended with PVDF1)

The blended dry coating of 95 wt % PVDF 1 (from Arkema) and 5 wt. % of pMMA/2-carboxyethyl acrylate/MAA (96.9/2.1/1.0 w/w/w) (Tg=125 C MW=140000) copolymer exhibited of peel bonding adhesion over the Al foil in battery cathode binders using 180 degree peel adhesion tests against 105 N/m from PVDF1 control.

### Example 7 (Functional pMMA Copolymer Containing 2-CEA+SR218A Blended with PVDF1)

The blended dry coating of 95 wt % PVDF 1 (from Arkema) and 5 wt. % of pMMA/2-carboxyethyl acrylate/ tert-butyl cyclohexyl methacrylate (96.9/2.6/0.5 w/w/w) (Tg=124 C MW=135000) copolymer exhibited 127 N/m of peel bonding adhesion over the Al foil in battery cathode binders using 180 degree peel adhesion tests against 105 N/m from PVDF1 control.

1. A binder for a lithium-ion battery comprising at least one vinylidene fluoride polymer and at least one acrylic copolymer, said acrylic copolymer comprising functional monomers comprising at least one type of functional group selected from the group consisting of: carboxyl, hydroxyl, carboxylic acid, carboxylic acid anhydride and epoxy, wherein said acrylic copolymer has a Tg of greater than 110 C, and wherein a 5% by weight solution of said vinylidene fluoride polymer in N-methyl-2-pyrrolidone exhibits a viscosity, measured at 23° C. with a controlled shear rate of 30 revolutions/min, equal to or greater than 125 millipascal-seconds, and less than 2000 millipascal-seconds, wherein the acrylic copolymer comprise less than 10 mol percent functional monomers, and wherein the fluoropolymer comprises greater than 80 wt % of the total weight of polymers in the polymer blend.

2. The binder as claimed in claim 1, wherein said binder contains, by weight, a content of acrylic copolymer equal to or greater than 2% and equal to or less than 15% by weight of the total weight of polymers in the polymer blend.

3. The binder as claimed in claim 2, wherein said binder contains, by weight, a content of acrylic copolymer equal to or less than 10%.

4. The binder as claimed in claim 1, wherein the viscosity of said solution of 5% by weight PVDF is equal to or greater than 300 millipascal-seconds, and less than 1500 millipascal-seconds.

5. The binder as claimed in claim 1, wherein the vinylidene fluoride polymer is a copolymer comprising at least one monomer selected from the group consisting of hexafluoropropylene (HFP), tetrafluoroethylene (TFE), vinyl carboxylic acid, phosphoric acid, sulfonic acid and their salts.

6. The binder as claimed in claim 1, wherein said acrylic copolymer has a molecular weight of greater than 80,000 g/mol.

7. The binder as claimed in claim 1, wherein said acrylic copolymers have high heat resistance as measure by having a Tg of greater 110° C.

8. The binder as claimed in claim 1, wherein said acrylic copolymer comprises functional monomer comprising at least one type of functional group selected from the group consisting of carboxyl and hydroxyl.

9. The binder as claimed in claim 1, wherein said acrylic copolymer comprises a poly(methyl methacrylate) copolymer comprising a functional monomer having a carboxyl functional group.

10. The binder as claimed in claim 1, wherein said acrylic copolymer comprises methyl methacrylate units and methacrylic acid units.

11. The binder as claimed in claim 1, wherein said acrylic copolymer comprises methyl methacrylate units and carboxylalkyl acrylate units or carboxylalkyl methacrylate units.

12. The binder as claimed in claim 1, wherein said acrylic copolymer further comprises a hydrophobic monomer.

13. The binder as claimed in claim 12, wherein said hydrophobic monomer is an acrylic monomer having a substituted cycloalkane group.

14. The binder as claimed in claim 12, wherein said hydrophobic monomer is selected from the group consisting of carboxylalkylacrylate monomer or oligomer, tert-butyl cyclohexyl (meth)acrylate, 3,3,5-trimethylcyclohexyl(meth)acrylate, isobornyl methyl acrylate (IBOMA) and isobornyl acrylate (IBOA).

15. The binder as claimed in claim 12, wherein the mol% of the hydrophobic monomer units is for 0 to 15 mol %.

16. An electrode for a lithium-ion battery of the type comprising a metal collector, at least one face of which is covered with a layer of substrate containing an active substance and the binder as claimed in claim 1.

17. The electrode as claimed in claim 16, wherein said substrate contains, by weight, a content of said binder of equal to or greater than 0.5% and of equal to or less than 5%.

18. The electrode as claimed in claim 16, wherein said substrate contains, by weight, a content of said binder equal to or greater than 1% and of equal to or less than 3%.

19. The electrode as claimed in claim 16, wherein said active substance comprises a lithium metal oxide and optionally carbon black.

20. The electrode as claimed in claim 16, wherein said substrate active substance comprises at least one ingredient selected from the group consisting of coke, carbon black, graphite, activated carbon and carbon fibers.

21. The electrode as claimed in claim 16, wherein said acrylic copolymer further comprises a hydrophobic monomer.
